(19) United States
(12) Patent Application Publication
(10) Pub. No.: US 2015/0291814 A1
(43) Pub. Date: Oct. 15, 2015

(54) NANOTECHNOLOGICAL THERMAL INSULATING COATING AND USES THEREOF

(71) Applicant: NANO LABS CORP., Detroit,, MI (US)

(72) Inventor: Victor Castano, Jurica Queretaro (MX)

(21) Appl. No.: 14/439,561

(22) PCT Filed: Oct. 30, 2013
(86) PCT No.: PCT/US13/67385

§ 371 Date: Apr. 29, 2015

Related U.S. Application Data
(60) Provisional application No. 61/720,716, filed on Oct. 31, 2012.

(51) Int. Cl. C09D 7/12

(52) U.S. Cl. CPC C09D 7/1266; C09D 7/1275; C08K 9/04

(57) ABSTRACT

The present document describes a ceramic and/or carbon nanoparticle having a chemically functionalized surface, a dispersion comprising the ceramic and/or carbon nanoparticle, a coating composition, such as a paint, comprising the dispersion, and processes for making the functionalized ceramic or carbon nanoparticles.

### BACKGROUND

(a) Field

The subject matter disclosed generally relates to dispersions which provides paints, namely films. More specifically, the subject matter relates to ceramic and/or carbon nanoparticle dispersions containing ceramic and/or carbon nanoparticle having chemically functionalized surface dispersed in a polymeric matrix.

(b) Related Prior Art

Polymeric resin dispersions have been widely utilized as a starting material for paints or coating of film-forming agents, for example, a starting material for a paint or a coating agent for coating an outside and inside of an aircraft, automobile, etc., an external wall surface, a floor material and furniture of house, and the likes. The paint film obtained based on these resin dispersions has a role of not only providing an agreeable appearance, but also protecting the material over which they are overlaid. For example, such paint compositions should provide, for example, with a measure of ultraviolet (UV) and infrared (IR) radiation resistance, acid rain resistance, resistance to fungi and bacteria, resistance to corrosion and oxidation, waterproofing, non-flammability, thermal insulation and be as environmentally friendly as possible.

Thus, there is a need for polymeric resin dispersions having improved resistance to environmental conditions such as UV and IR radiation, acid rain, heat and cold, fungi and bacteria, corrosion and oxidation.

Furthermore, there is a need to polymeric resin dispersions having improved waterproofing properties, and that have low or non-flammability properties and thermal insulation.

### SUMMARY

According to an embodiment, there is provided a ceramic and/or carbon nanoparticle having a chemically functionalized surface, the ceramic and/or carbon nanoparticle may have a size from about 8 nm to about 120 nm.

The ceramic and/or carbon nanoparticle may be a nanoparticle made from a material chosen from an aluminum oxide (Al₂O₃), silicon dioxide (SiO₂), zirconium oxide (ZrO₂), titanium oxide (Ti02), zinc oxide (ZnO), cerium oxide (IV) (CeO₂), beryllium oxide (BeO), calcium carbonate (CaCO₃), calcium phosphate [Ca₃(PO₄)₂], a carbide, a boride, a nitride, a silicide and a carbon nanotube.

The carbide may be chosen from calcium carbide (CaC₂), boron carbide (B₄C), silicon carbide (SiC), titanium carbide (TiC), tungsten carbide (WC), iron carbide (Fe₃C), zirconium carbide (ZrC), hafnium carbide (HfC), vanadium carbide (VC), niobium carbide (NbC), a tantalum carbide (TaCx, wherein x is 0.4 to 1), a chromium carbide, and molybdenum carbide (Mo₂C).

The chromium carbide may be chosen from Cr₃C₂, Cr₇C₃, and Cr₂₃C₆.

The boride may be chosen from silicon triboride (SiB₃), silicon hexaboride (SiB₆), titanium diboride (TiB₂), zirconium diboride (ZrB₂), and hafnium diboride (HfB₂).

The nitride may be chosen from titanium nitride (TiN), silicon nitride (Si₃N₄), and boron nitride (BN).

The carbon nanotube may be chosen from a single wall nanotube, a multi-walled nanotube, or combinations thereof.

The chemically functionalized surface may comprise (a) a hydroxyl group, (b) a carboxyl group, (c) an amine group, (d) a C₁-C₃₀-alkyl group, linear or branched, unsubstituted or substituted with 1-3 halogens, or Na and unsubstituted or substituted with one group selected from —OH, an —OC₁₋₃₀alkyl unsubstituted or substituted with 1-3 halogens or Na, an —SOₓC₁₋₃₀alkyl group, linear or branched, and —CN, (e) a —C(═O)H group, (f) a —C(═O)C₁₋₃₀alkyl group, linear or branched, unsubstituted or substituted with 1-3 halogens, (g) a —CN group, (h) a —HC═NOH group, (i) a —(CH₃)C═NOH group, (j) a —HC═NOC₁₋₃₀alkyl group, linear or branched, unsubstituted or substituted with 1-3 halogens, (k) a —(CH₃)C═NOC₁₋₃₀alkyl group, linear or branched, unsubstituted or substituted with 1-3 halogens (l) a —C(═O)OC₁₋₃₀alkyl group, linear or branched, unsubstituted or substituted with 1-3 halogens, (m) a —C(═O)NHR⁶ group, (n) a —CH═CH-Phenyl group wherein —CH═CH— is unsubstituted or substituted with 1-2 substituents independently selected from halogen and C₁₋₂alkyl optionally substituted with 1-3 F, (o) a —CH₂CH₂-Phenyl wherein —CH₂CH₂— is unsubstituted or substituted with 1-4 substituents independently selected from halogen and C₁₋₂alkyl unsubstituted or substituted with 1-3 F, (p) a Phenyl group, (q) a —HET-Phenyl group, wherein HET is a 5- or 6-membered heteroaromatic ring containing 1-3 heteroatoms selected from O, N and S, (r) a —C≡C-Phenyl group, and (s) a —CH₂-Phenyl group, wherein the —CH₂— group of —CH₂-Phenyl is unsubstituted or substituted with 1-2 substituents independently selected from halogen and C₁₋₂alkyl unsubstituted or substituted with 1-3 F, (t) [symbol] (O)ₓSi(OCₙH₂ₙ₊₁)ₓ(CH₂)ₙR⁷, (u) [symbol] Si(OCₙH₂ₙ₊₁)ₓ(CH₂)ₙR⁷

and Phenyl and HET in all occurrences may be unsubstituted or substituted with 1-3 substituents independently selected from (i) halogen, (ii) —C(═O)OC₁₋₃₀alkyl unsubstituted or substituted with 1-3 halogens, (iii) —C(═O)OH (iv) —C₁₋₃₀alkyl unsubstituted or substituted with 1-3 halogens, (v) —OC₁₋₃₀ alkyl unsubstituted or substituted with 1-3 halogens, (vi) —SOₓMe, (vii) —SO₂NH₂, and combinations thereof;
R⁶ may be selected from the group consisting of H, C₁₋₃₀alkyl unsubstituted or substituted with 1-3 halogens, Phenyl, and —CH₂-Phenyl, wherein Phenyl in both occurrences may be unsubstituted or substituted with 1-3 substituents independently selected from (i) halogen, (ii) —C(═O)OC₁₋₃₀alkyl unsubstituted or substituted with 1-3 halogens, (iii) —C(═O)OH (iv) C₁₋₃₀ alkyl unsubstituted or substituted with 1-3 halogens, and (v) —OC₁₋₃₀alkyl unsubstituted or substituted with 1-3 halogens;
R⁷ may be selected from the group consisting of H, a hydroxyl group, a carboxyl group, an amine group, a thiol group, a c₁-C₃₀-alkyl group, linear or branched, unsubstituted or substituted with 1-3 halogens, or Na and unsubstituted or substituted with one group selected from —OH, an —OC₁₋₃₀alkyl unsubstituted or substituted with 1-3 halogens or Na, an —SOₓC₁₋₃₀alkyl group, linear or branched, and —CN,

x may be independently chosen from 0, 1, or 2,

n may be independently chosen from 1 to 30, and

[symbol] may be a single, double or triple bond,

and combinations thereof.

The ceramic and/or carbon nanoparticle dispersion of the present invention may comprise at least one ceramic and/or carbon nanoparticle having a chemically functionalized surface dispersed in a polymeric matrix.

The dispersion may comprise from about 0.1% (w/v) to about 10% (w/v) of the ceramic and/or carbon nanoparticle having a chemically functionalized surface.

The polymeric matrix may comprise an acrylic resin, an elastomeric resin, an epoxy resin, a polyurethane resin, an alkyd resin, a vinyl-acrylic resin, a polyester resin, a melamine resin, an oil or combinations thereof.

The acrylic resin may be chosen from a polymethyl acrylate resin, polymethyl methacrylate resin, and combinations thereof.

The elastomeric resin may be chosen from cis-1,4-polyisoprene natural rubber, and trans-1,4-polyisoprene gutta-percha, a synthetic polyisoprene, a polybutadiene, a polychloroprene, a copolymer of isobutylene and isoprene, an halogenated copolymer of isobutylene and isoprene, a copolymer of styrene and butadiene, a copolymer of butadiene and acrylonitrile, a copolymer of ethylene and propylene, an ethylene propylene diene rubber, a terpolymer of ethylene, a epichlorohydrin rubber, a polyacrylic rubber, a silicone rubber, fluorosilicone rubber, a fluoroelastomer, a perfluoroelastomers, polyether block amide elastomer, a chlorosulfonated polyethylene, and an ethylene-vinyl acetate.

The dispersion may further comprise an aluminum slurry. The aluminum slurry may contain nanoparticles from about 1% (w/v) and about 3% (w/v). The aluminum slurry may contain nanoparticles from about 2.5% (w/v) to about 50% (w/v).

The dispersion may further comprise a flame retardant.

The retardant may be chosen from Huntite (Mg₃Ca(CO₃)₄), hydromagnesite (Mg₅(CO₃)4(OH)₂.4H₂O), aluminium hydroxide (Al(OH)₃), magnesium hydroxide (Mg(OH)₂), a magnesium hydroxide particle, melamine cyanurate, melamine polyphosphate, or combinations thereof.

The magnesium hydroxide particle may be a particle of size between about 100 nm to about 3000 nm.

The magnesium hydroxide particle may further be coated with a layer of sodium stearate.

The dispersion may further comprise a rheology modifier.

The rheology modifier may be chosen from a modified hydrogenated castor oil, a bentonite, a synthetic polyamide wax, a polysaccharide and combinations thereof. The polysaccharide may be chosen from a methylcellulose, a hydroxypropyl methylcellulose, a hydroethylcellulose, a methyl ethyl hydroxyethyl cellulose, a hydrophobical modified ethyl hydroxyethyl cellulose, an ethylene-vinyl-acetate copolymer, an emulsion of an ethylene-vinyl-acetate copolymer, and combinations thereof.

The dispersion may further comprise a thickening agent.

The thickening agent may be chosen from an acrylic thickener, a polyvenyle co-polymer and a polyvenyle homopolymer.

The dispersion may further comprise an anti-bacteria chemical.

The anti-bacteria chemical may be chosen from methylene bis(thiocyanate), 2-(Thiocyanomethylthio)benzothiazole, thiodazine-thione, 2,3,4,6-tetrachloro 4(methylsulfonyl)pyridine, silver nanoparticles or combinations thereof. The silver nanoparticles may have size ranging between about 10 to about 90 nm. The dispersion may have a thermal conductivity (K) between about 0.001 and about 0.1 BTU/h.

The dispersion may reflect up to 82% of UV radiation.

The paint composition may have a density between about 0.97 to about 1.42 kg/m³ (Kg/L).

According to another embodiment, the coating composition may comprise the dispersion in association with a medium.

The medium may be a paint, a stain, a lacquer or a grout.

According to another embodiment, the coating composition may further comprise at least one colored pigment, from about 0.1% (w/v) to about 3% (w/v) in the case of nanopigments and from about 2.5% (w/v) to 30% (w/v) in the case of micropigments.

The coating composition may be waterproof.

The coating composition may be resistant to fungal growth.

According to a further embodiment, there is provided a surface coated with the coating composition.

According to another embodiment, there is provided process for preparing a ceramic or carbon nanoparticle having a chemically functionalized surface comprising:

a) contacting a ceramic and/or carbon nanoparticle with a functionalizing agent in the presence of an inert atmosphere in a suitable first solvent at a temperature and for a time sufficient to yield a functionalized ceramic and/or carbon nanoparticle.

The process may further comprise step b):

b) washing said functionalized ceramic and/or carbon nanoparticle in a second suitable solvent to obtain a washed functionalized ceramic and/or carbon nanoparticle.

The process may further comprise step c):

c) curing said washed functionalized ceramic and/or carbon nanoparticle to at a temperature and for a time sufficient to yield a cured functionalized ceramic and/or carbon nanoparticle.

The functionalizing agent may be chosen from 3-mercaptopropyltrimethoxysilane, (3-aminopropyl)-triethoxysilane, (3-aminopropyl)-diethoxy-methylsilane, (3-aminopropyl)-dimethyl-ethoxysilane, (3-aminopropyl)-trimethoxysilane and combinations thereof.

The inert atmosphere may be a N₂ atmosphere, or with a strong flux of clean, dried air, in an industrial environment.

The time sufficient may be from about 10 h to about 112 h.

The first suitable solvent may be chosen from anhydrous xylene, dry toluene, methyl amyl ketone, n-butyl propionate and isobutyl isobutyrate and combinations and co-solvents prepared with them.

The second suitable solvent may be chosen from xylene, toluene, ethanol, acetone, methyl amyl ketone, n-butyl propionate and isobutyl isobutyrate and combinations and co-solvents prepared with them.

The temperature may be chosen from about 25° C. to about 70° C.

The temperature may be from about 65° C. to about 130° C.

The time sufficient may be from about 8 h to about 12 h.

According to another embodiment, there is provided a process for the preparation of a dispersion comprising a ceramic and/or carbon nanoparticle having a chemically functionalized surface, the process comprising the steps of:

a) dispersing a mixture of ceramic nanoparticles including at least one type of a ceramic and/or carbon nanoparticle having a chemically functionalized surface in a polymeric matrix, by using a solvent or water; and

b) curing said mixture of the and/or carbon nanoparticles in the polymeric matrix.

The curing may be at room temperature, by heating, by UV curing, by electron beam curing, or catalyzed by a reaction of reactive radicals.

According to another embodiment there is provided the process of the present invention comprising step a′) prior to step a):
a′) chemically functionalizing a ceramic and/or carbon nanoparticles described according to the present invention.

The following terms are defined below.

Abbreviations used herein have their conventional meaning within the chemical and biological arts.

“alkyl,” by itself or as part of another substituent, means, unless otherwise stated, a straight (i.e. unbranched) or branched chain, or cyclic hydrocarbon radical, or combination thereof, which may be fully saturated, mono- or polyunsaturated and can include di- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, cyclohexyl, (cyclohexyl)methyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. Alkyl groups which are limited to hydrocarbon groups are termed “homoalkyl”. Alkyl groups are optionally substituted with one or more halogen atoms.

“Alkylene” by itself or as part of another substituent means a divalent radical derived from an alkyl, as exemplified, but not limited, by —CH₂CH₂CH₂CH₂—, —CH₂CH═CHCH₂—, —CH₂C≡CCH₂—, —CH₂CH₂CH(CH₂CH₂CH₃)CH₂—. Typically, an alkyl (or alkylene) group will have from 1 to 24 carbon atoms, with those groups having 10 or fewer carbon atoms being preferred in the present invention. A “lower alkyl” or “lower alkylene” is a shorter chain alkyl or alkylene group, generally having eight or fewer carbon atoms.

“Alkynyl” means carbon chains which contain at least one carbon-carbon triple bond, and which may be linear or branched or combinations thereof. Examples of alkynyl include ethynyl, propargyl, 3-methyl-1-pentynyl, 2-heptynyl and the like.

“Cycloalkyl” means mono- or bicyclic saturated carbocyclic rings, each of which having from 3 to 10 carbon atoms. A “fused analog” of cycloalkyl means a monocyclic rings fused to an aryl or heteroaryl group in which the point of attachment is on the non-aromatic portion. Examples of cycloalkyl and fused analogs thereof include cyclopropyl, cyclobutyl, cyclopentyl, cyclohexyl, cycloheptyl, tetrahydronaphthyl, decahydronaphthyl, indanyl, and the like.

“Alkoxy” means alkoxy groups of a straight or branched having the indicated number of carbon atoms. C₁₋₆ alkoxy, for example, includes methoxy, ethoxy, propoxy, isopropoxy, and the like.

“Heteroalkyl,” by itself or in combination with another term, means, unless otherwise stated, a stable straight or branched chain, or cyclic hydrocarbon radical, or combinations thereof, consisting of at least one carbon atoms and at least one heteroatom selected from the group consisting of O, N, P, Si and S, and wherein the nitrogen, phosphorus, and sulfur atoms may optionally be oxidized and the nitrogen heteroatom may optionally be quaternized. The heteroatom(s) O, N, P and S and Si may be placed at any interior position of the heteroalkyl group or at the position at which alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, CH═N—OCH₃, —CH═CH—N(CH₃)—CH₃, —O—CH₃, —O—CH₂—CH₃, and —CN. Up to two or three heteroatoms may be consecutive, such as, for example, —CH₂—NH—OCH₃ and —CH₂—O—Si(CH₃)₃. Similarly, the term “heteroalkylene” by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both of the chain termini (e.g., alkyleneoxo, alkylenedioxo, alkyleneamino, alkylenediamino, and the like). Still further, for alkylene and heteroalkylene linking groups, no orientation of the linking group is implied by the direction in which the formula of the linking group is written. For example, the formula —C(O)OR′— represents both —C(O)OR′— and —R′OC(O)—. As described above, heteroalkyl groups, as used herein, include those groups that are attached to the remainder of the molecule through a heteroatom, such as —C(O)R′, —C(O)NR′, —NR′R″, —OR′, —SR′, and/or —SO₂R′. Where “heteroalkyl” is recited, followed by recitations of specific heteroalkyl groups, such as —NR′R″ or the like, it will be understood that the terms heteroalkyl and —NR′R″ are not redundant or mutually exclusive. Rather, the specific heteroalkyl groups are recited to add clarity. Thus, the term “heteroalkyl” should not be interpreted herein as excluding specific heteroalkyl groups, such as —NR′R″ or the like.

“Cycloalkoxy” means cycloalkyl as defined above bonded to an oxygen atom, such as cyclopropyloxy.

“Fluoroalkoxy” means alkoxy as defined above wherein one or more hydrogen atoms have been replaced by fluoro atoms.

“Aryl” means mono- or bicyclic aromatic rings containing only carbon atoms. A “fused analog” of aryl means an aryl group fused to a monocyclic cycloalkyl or monocyclic heterocyclyl group in which the point of attachment is on the aromatic portion. Examples of aryl and fused analogs thereof include phenyl, naphthyl, indanyl, indenyl, tetrahydronaphthyl, 2,3-dihydrobenzofuranyl, dihydrobenzopyranyl, 1,4-benzodioxanyl, and the like.

“Heteroaryl” means a mono- or bicyclic aromatic ring containing at least one heteroatom selected from N, O and S, with each ring containing 5 to 6 atoms. A “fused analog” of heteroaryl means a heteroaryl group fused to a monocyclic cycloalkyl or monocyclic heterocyclyl group in which the point of attachment is on the aromatic portion. Examples of heteroaryl include pyrrolyl, isoxazolyl, isothiazolyl, pyrazolyl, pyridyl, oxazolyl, oxadiazolyl, thiadiazolyl, thiazolyl, imidazolyl, triazolyl, tetrazolyl, furanyl, triazinyl, thienyl, pyrimidyl, pyridazinyl, pyrazinyl, benzoxazolyl, benzothiazolyl, benzimidazolyl, benzofuranyl, benzothiophenyl, furo(2,3-b)pyridyl, quinolyl, indolyl, isoquinolyl, and the like.

The said aryl groups and said heteroaryl groups referred to in the definitions are unsubstituted or are substituted by at least one substituent selected from the group consisting of substituents a;

The said substituents a are selected from the group consisting of halogen atoms, alkyl groups having from 1 to 4 carbon atoms, alkoxy groups having from 1 to 4 carbon atoms, haloalkyl groups having from 1 to 4 carbon atoms, haloalkoxy groups having from 1 to 4 carbon atoms, cyano groups, alkynyl groups having from 2 to 6 carbon atoms, alkanoyl groups having from 1 to 5 carbon atoms, cycloalkyl groups having from 3 to 7 ring atoms, heteroaryl groups, aryl groups, aralkoxy groups having from 7 to 10 carbon atoms, arylcarbonyl groups, two adjacent-x groups are optionally joined together to form an alkylene or an alkenylene chain having 3 or 4 carbon atoms, aminocarbonyl groups, alkenyl groups having from 2 to 5 carbon atoms, alkylthio groups having from 1 to 4 carbon atoms, aminosulfinyl groups, aminosulfonyl groups, hydroxy groups, hydroxyalkyl groups having from 1 to 4 carbon atoms, nitro groups, amino groups, carboxy groups, alkoxycarbonyl groups having from 2 to 5 carbon atoms, alkoxyalkyl groups having from 1 to 4 carbon atoms, alkylsulfonyl groups having from 1 to 4 carbon atoms, alkanoylamino groups having from 1 to 4 carbon atoms, alkanoyl(alkyl)amino groups having from 1 to 6 carbon atoms, alkanoylaminoalkyl groups having from 1 to 6 carbon atoms in both the alkanoyl and alkyl part, alkanoyl(alkyl)aminoalkyl groups having from 1 to 6 carbon atoms in both the alkanoyl and each alkyl part, alkylsulfonylamino groups having from 1 to 4 carbon atoms, mono- or di-alkylaminocarbonyl groups having from 1 to 6 carbon atoms, mono- or di-alkylaminosulfinyl groups having from 1 to 6 carbon atoms, mono- or di alkylaminosulfonyl groups having from 1 to 6 carbon atoms, aminoalkyl groups having from 1 to 4 carbon atoms, mono- or di-alkylamino groups having from 1 to 6 carbon atoms, mono- or di-alkylaminoalkyl groups having from 1 to 6 carbon atoms in each alkyl part, aralkyl groups having from 7 to 10 carbon atoms, heteroarylalkyl groups having from 1 to 4 carbon atoms in the alkyl part, heteroarylalkoxy groups having from 1 to 4 carbon atoms in the alkoxy part and alkylsulfonylamino groups having from 1 to 4 carbon atoms;

“Heterocyclyl” means mono- or bicyclic saturated rings containing at least one heteroatom selected from N, S and O, each of said ring having from 3 to 10 atoms in which the point of attachment may be carbon or nitrogen. A “fused analog” of heterocyclyl means a monocyclic heterocycle fused to an aryl or heteroaryl group in which the point of attachment is on the non-aromatic portion. Examples of “heterocyclyl” and fused analogs thereof include pyrrolidinyl, piperidinyl, piperazinyl, imidazolidinyl, 2,3-dihydrofuro(2,3-b)pyridyl, benzoxazinyl, tetrahydrohydroquinolinyl, tetrahydroisoquinolinyl, dihydroindolyl, and the like. The term also includes partially unsaturated monocyclic rings that are not aromatic, such as 2- or 4-pyridones attached through the nitrogen or N-substituted-(1H,3H)-pyrimidine-2,4-diones (N-substituted uracils).

“halo” or “halogen,” by themselves or as part of another substituent, mean, unless otherwise stated, a fluorine, chlorine, bromine, or iodine atom. Additionally, terms such as “haloalkyl,” are meant to include monohaloalkyl and polyhaloalkyl. For example, the term “halo(C₁-C₄)alkyl” is mean to include, but not be limited to, trifluoromethyl, 2,2,2-trifluoroethyl, 4-chlorobutyl, 3-bromopropyl, and the like.

“carbon nanoparticle” is intended to mean, nanotubes such as single wall nanotubes and multi-walled nanotubes, as well as other carbon nanostructures such as fullerene and graphene nanoparticles.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIGS. 1A to F illustrate temperature measurement on uncoated surfaces (A, C, and E), coated with a competing product (B) or on surfaces coated with a paint composition according to the present invention (D, F).

### DETAILED DESCRIPTION

In embodiment there is disclosed a ceramic and/or carbon nanoparticle having a chemically functionalized surface, and having a size from about 8 nm to about 120 nm.

According to an embodiment, the ceramic nanoparticle may be a nanoparticle made from a material chosen from an aluminum oxide (Al₂O₃), silicon dioxide (SiO₂), zirconium oxide (ZrO₂), titanium oxide (TiO₂), zinc oxide (ZnO), cerium oxide (IV) (CeO₂), beryllium oxide (BeO), calcium carbonate (CaCO₃), calcium phosphate [Ca₃(PO₄)₂], a carbide, a boride, a nitride, and a silicide or other similar or equivalent nanoparticles. Also, carbon, fullerene and graphene nanoparticles are included.

Examples of suitable carbides include but are not limited to calcium carbide (CaC₂), boron carbide (B₄C), silicon carbide (SiC), titanium carbide (TiC), tungsten carbide (WC), iron carbide (Fe₃C), zirconium carbide (ZrC), hafnium carbide (HfC), vanadium carbide (VC), niobium carbide (NbC), a tantalum carbide (TaCₓ, wherein x is 0.4 to 1), a chromium carbide, and molybdenum carbide (Mo₂C). The chromium carbide can be for example Cr₃C₂, Cr₇C₃, and Cr₂₃C₆, and the use of hexavalent chromium [Cr(VI)] in the present inventions must be avoided.

Examples of suitable borides include but are not limited to silicon triboride (SiB₃), silicon hexaboride (SiB₆), titanium diboride (TiB₂), zirconium diboride (ZrB₂), and hafnium diboride (HfB₂).

Examples of suitable nitrides include but are not limited to titanium nitride (TiN), silicon nitride (Si₃N₄), and boron nitride (BN).

According to another embodiment of the present invention, chemically functionalized surface comprises (a) a hydroxyl group, (b) a carboxyl group, (c) an amine group, (d) a C₁-C₃₀-alkyl group, linear or branched, unsubstituted or substituted with 1-3 halogens, or Na and unsubstituted or substituted with one group selected from —OH, an —OC₁₋₃₀alkyl unsubstituted or substituted with 1-3 halogens or Na, an —SOₓC₁₋₃₀alkyl group, linear or branched, and —CN, (e) a —C(═O)H group, (f) a —C(═O)C₁₋₃₀ alkyl group, linear or branched, unsubstituted or substituted with 1-3 halogens, (g) a —CN group, (h) a —HC═NOH group, (i) a —(CH₃)C═NOH group, (j) a —HC═NOC₁₋₃₀alkyl group, linear or branched, unsubstituted or substituted with 1-3 halogens, (k) a —(CH₃)C═NOC₁₋₃₀alkyl group, linear or branched, unsubstituted or substituted with 1-3 halogens (l) a —C(═O)OC₁₋₃₀alkyl group, linear or branched, unsubstituted or substituted with 1-3 halogens, (m) a —C(═O)NHR₆ group, (n) a —CH═CH-Phenyl group wherein —CH═CH— is unsubstituted or substituted with 1-2 substituents independently selected from halogen and C₁₋₂alkyl optionally substituted with 1-3 F, (o) a —CH₂CH₂-Phenyl wherein —CH₂CH₂— is unsubstituted or substituted with 1-4 substituents independently selected from halogen and C₁₋₂alkyl unsubstituted or substituted with 1-3 F, (p) a Phenyl group, (q) a —HET-Phenyl group, wherein HET is a 5- or 6-membered heteroaromatic ring containing 1-3 heteroatoms selected from O, N and S, (r) a —C≡C-Phenyl group, and (s) a —CH₂-Phenyl group, wherein the —CH₂— group of —CH₂-Phenyl is unsubstituted or substituted with 1-2 substituents independently selected from halogen and C₁₋₂alkyl unsubstituted or substituted with 1-3 F, (t) [symbol] (O)ₓSi(OCₙH₂ₙ₊₁)ₓ(CH₂)ₙR⁷, (u) [symbol] Si(OCₙH₂ₙ₊₁)ₓ(CH₂)ₙR⁷,

wherein Phenyl and HET in all occurrences are unsubstituted or substituted with 1-3 substituents independently selected from (i) halogen, (ii) —C(═O)OC₁₋₃₀alkyl unsubstituted or substituted with 1-3 halogens, (iii) —C(═O)OH (iv) C₁₋₃₀alkyl unsubstituted or substituted with 1-3 halogens, (v) —OC₁₋₃₀alkyl unsubstituted or substituted with 1-3 halogens, (vi) —SOₓMe, (vii) —SO₂NH₂, and combinations thereof;
R⁶ may be selected from the group consisting of H, C₁₋₃₀alkyl unsubstituted or substituted with 1-3 halogens, Phenyl, and —CH₂-Phenyl, wherein Phenyl in both occurrences is unsubstituted or substituted with 1-3 substituents independently selected from (i) halogen, (ii) —C(═O)OC₁₋₃₀ alkyl unsubstituted or substituted with 1-3 halogens, (iii) —C(═O)OH (iv) C₁₋₃₀alkyl unsubstituted or substituted with 1-3 halogens, and (v) —OC₁₋₃₀ alkyl unsubstituted or substituted with 1-3 halogens;
R⁷ is selected from the group consisting of H, a hydroxyl group, a carboxyl group, an amine group, a thiol group, a C₁-C₃₀-alkyl group, linear or branched, unsubstituted or substituted with 1-3 halogens, or Na and unsubstituted or substituted with one group selected from —OH, an —OC₁₋₃₀alkyl unsubstituted or substituted with 1-3 halogens or Na, an —SOₓC₁₋₃₀alkyl group, linear or branched, and —CN,
x is independently chosen from 0, 1, or 2,
n is independently chosen from 1 to 30, and [symbol]
is a single, double or triple bond,

In another embodiment there is disclosed a ceramic and/or carbon nanoparticle dispersion comprising at least one ceramic or carbon nanoparticle having a chemically functionalized surface dispersed in a polymeric matrix.

According to an embodiment, the dispersion may comprise from about 0.1% (w/v) to about 10% (w/v) of the ceramic and/or carbon nanoparticle having a chemically functionalized surface. According to another embodiment, when more than one ceramic and/or carbon nanoparticle having a chemically functionalized surface is dispersed in the dispersion, the relative ratios between the nanoparticles themselves vary from about 0.1%:99.9% to about 90%:10%, or from about 1%:99%, or from about 5%:95%, or from about 7.5% to about 92.5%, or from about 10%:90%, or from about 15%:85%, or from about 20%:80%, or from about 25%:75%, or from about 30%:70%, or from about 33.3%:66.6%, or from about 35%:65%, or from about 40%:60%, or from about 45%:55%, or from about 50%:50%, or from about 55%:45%, or from about 60%:40%, or from about 65%:35%, or from about 66.6%:33.3%, or from about 70%:30%, or from about 75%:25%, or from about 80%:20%, or from about 85%:15%, or from about 90%:10%. According to an embodiment, the relationships of the nanoparticles utilized in the present inventions depend on the specific precursor or resin employed and are typically from about or from about 50%:50% to or from about 33.3%:66.6% or from about 66.6%:33.3%.

According to another embodiment, the polymeric matrix may be any suitable acrylic resin, elastomeric resin, epoxy resin, polyurethane resin, alkyd resin, vinyl-acrylic resin, polyester resin, melamine resin, and oils or combinations thereof. The resins include both solvent-based and water-borne resins.

Examples of suitable acrylic resins include but are not limited to polymethyl acrylate resins, and polymethyl methacrylate resins, and combinations thereof.

Examples of suitable elastomeric resins include but are not limited to cis-1,4-polyisoprene natural rubber, trans-1,4-polyisoprene gutta-percha, a synthetic polyisoprene, a polybutadiene, a polychloroprene, a copolymer of isobutylene and isoprene, an halogenated copolymer of isobutylene and isoprene, a copolymer of styrene and butadiene, a copolymer of butadiene and acrylonitrile, a copolymer of ethylene and propylene, an ethylene propylene diene rubber, a terpolymer of ethylene, a epichlorohydrin rubber, a polyacrylic rubber, a silicone rubber, fluorosilicone rubber, a fluoroelastomer, a perfluoroelastomers, polyether block amide elastomer, a chlorosulfonated polyethylene, and an ethylene-vinyl acetate.

According to another embodiment of the present invention, the dispersion may further contain aluminum slurry or natural or synthetic talc to increase reflectivity of the paint. The aluminum slurry used is of the type used commercially for polishing or grinding or blasting. According to an embodiment, the aluminum slurry may be a slurry of nanoparticles, and may be present between about 1% (w/v) and about 3% (w/v). According to another embodiment, the aluminum slurry may be a thicker (paste-like) slurry composed of microparticles, which may be present between about 2.5% (w/v) to about 50% (w/v).

According to another embodiment, the dispersion of the present invention may further include a flame retardant, such as for example Huntite (Mg₃Ca(CO₃)₄), hydromagnesite (Mg₅(CO₃)₄(OH)₂.4H₂O), aluminium hydroxide (Al(OH)₃), magnesium hydroxide (Mg(OH)₂), a magnesium hydroxide particle, melamine cyanurate, melamine polyphosphate, or combinations thereof. According to an embodiment, the magnesium hydroxide particle may be a particle of size between about 100 nm to about 3000 nm. According to yet another embodiment, the magnesium hydroxide particle is further coated with a layer of sodium stearate.

According to another embodiment of the present invention, the dispersion of the present invention may further comprise a rheology modifier. Non limiting examples of suitable rheology modifier include modified hydrogenated castor oil, bentonite, synthetic polyamide wax, polysaccharide, and combinations thereof. According to an embodiment, the polysaccharide may be chosen from a methylcellulose, a hydroxypropyl methylcellulose, a hydroethylcellulose, a methyl ethyl hydroxyethyl cellulose, a hydrophobical modified ethyl hydroxyethyl cellulose, an ethylene-vinyl-acetate copolymer, an emulsion of an ethylene-vinyl-acetate copolymer, and combinations thereof. Suitable commercially available rheology modifiers include Methocel™, Natrosol™, Cellosize™, Bermocoll™, Aquathix™ and other equivalent commercially-available products. According to an embodiment, the rheology modifier may be present in the range of from about 0.5% (w/v) to about 5% (w/v), or from about 1.0% (w/v) to about 5% (w/v), or from about 1.5% (w/v) to about 5% (w/v), or from about 2.0% (w/v) to about 5% (w/v), or from about 2.5% (w/v) to about 5% (w/v), or from about 3.0% (w/v) to about 5% (w/v), or from about 3.5% (w/v) to about 5% (w/v), or from about 4.0% (w/v) to about 5% (w/v), or from about 4.5% (w/v) to about 5% (w/v), or from about 0.5% (w/v) to about 4.5% (w/v), or from about 1.0% (w/v) to about 4.5% (w/v), or from about 1.5% (w/v) to about 4.5% (w/v), or from about 2.0% (w/v) to about 4.5% (w/v), or from about 2.5% (w/v) to about 4.5% (w/v), or from about 3.0% (w/v) to about 4.5% (w/v), or from about 3.5% (w/v) to about 4.5% (w/v), or from about 4.0% (w/v) to about 4.5% (w/v), or from about 0.5% (w/v) to about 4% (w/v), or from about 1.0% (w/v) to about 4% (w/v), or from about 1.5% (w/v) to about 4% (w/v), or from about 2.0% (w/v) to about 4% (w/v), or from about 2.5% (w/v) to about 4% (w/v), or from about 3.0% (w/v) to about 4% (w/v), or from about 3.5% (w/v) to about 4% (w/v), or from about 0.5% (w/v) to about 3.5% (w/v), or from about 1.0% (w/v) to about 3.5% (w/v), or from about 1.5% (w/v) to about 3.5% (w/v), or from about 2.0% (w/v) to about 3.5% (w/v), or from about 2.5% (w/v) to about 3.5% (w/v), or from about 3.0% (w/v) to about 3.5% (w/v), or from about 0.5% (w/v) to about 3% (w/v), or from about 1.0% (w/v) to about 3% (w/v), or from about 1.5% (w/v) to about 3% (w/v), or from about 2.0% (w/v) to about 3% (w/v), or from about 2.5% (w/v) to about 3% (w/v), or from about 0.5% (w/v) to about 2.5% (w/v), or from about 1.0% (w/v) to about 2.5% (w/v), or from about 1.5% (w/v) to about 2.5% (w/v), or from about 2.0% (w/v) to about 2.5% (w/v), or from about 0.5% (w/v) to about 2% (w/v), or from about 1.0% (w/v) to about 2% (w/v), or from about 1.5% (w/v) to about 2% (w/v), or from about 0.5% (w/v) to about 1.5% (w/v), or from about 1.0% (w/v) to about 1.5% (w/v), or from about 0.5% (w/v) to about 1% (w/v).

According to another embodiment, the dispersion of the present invention may further comprise a thickening agent. Examples of suitable thickening agents include but are not limited to acrylic thickeners, polyvenyle co-polymers, polyvenyle homopolymers, and combinations thereof.

According to another embodiment, the dispersion of the present invention may further comprise an anti-bacteria chemical. Examples of suitable anti-bacteria chemical include but are not limited to methylene bis(thiocyanate), 2-(thiocyanomethylthio)benzothiazole, thiodazine-thione, 2,3,4,6-tetrachloro 4(methylsulfonyl)pyridine, silver nanoparticles or combinations thereof. According to another embodiment, the silver nanoparticles may have size ranging between about 10 to about 90 nm.

According to another embodiment, there is disclosed a paint composition comprising the dispersion of the present invention in association with a medium. The paint composition may be for example, a paint, or a lacquer. It may also include at least one colored pigment (from about 0.1% (w/v) to about 3% (w/v) to provide nice looking colored products, in the case of using nanopigments. According to another embodiment, micro pigments may also be used, the range from 2.5% (w/v) to about 50% (w/v).

According to an embodiment of the present invention, the paint compositions of the present invention provide an insulating coating nanotechnology of a very low thermal conductivity, which isolates the outdoor temperature, maintaining a pleasant temperature inside, making a considerable saving of energy, is an excellent Waterproof Protector and Fire Retardant. They do not allow the transmission of temperature through the coated elements. According to an embodiment, the coating composition may have coefficient of thermal conductivity of K=0.059 BTU/h, which allow a decrease of the temperature of the protected body up to −18° C., depending on the material which is applied. Resistant to temperatures from −20° C. to 450° C. For example at the time of highest incidence of sunlight, coating with a coating composition according to the present invention increases the pleasantness and comfort of a house. According to another embodiment, the coating composition of the present invention has greater mechanical flexibility up to about 270° C. It may be stored for up to a maximum of 60 months, at a storage temperature of 4° C. or higher, up to 40° C.

### Reflection of Ultraviolet Rays

According to another embodiment, the coating composition of the present invention is capable of reflecting about 82% of UV rays by its white color and design formula, which results in a significant temperature differential of surfaces over which it is overlaid. This property helps to prevent expansion and contraction of the surface or body covered, avoiding cracks in cement or concrete and structural problems on metal surfaces. It therefore is ideal to protect a roof from UV and IR radiations, avoiding contractions and expansions at the same.

### Waterproof and Other Protections

According to another embodiment, the coating composition of the present invention is a water repellent that does not allow water infiltration, or corrosion and rusting of the surface or body covered, giving longer life span. It also protects against acid rains, and it does not absorb moisture, does not emit or keep odors (such as environmental or body odors), does not allow the formation of fungi and bacteria. It also displays auto-wash properties with the rain, maintaining a shimmering white color; it is not flammable. It reduces corrosion and oxidation, reduces power consumption in units with air conditioning and refrigeration (up to 40% savings) by eliminating thermal load, and it can be applied on almost any surface (e.g. concrete, cement, Polycarbonate, Acrylic, galvanized and asbestos, drywall, brick, and concrete block partition, etc).

The coating composition of the present invention may be normally applied directly, often without the need to remove products previously used to coat the surface, except when the surface having high porosity, severe damages or for the repair of which involve sealant and/or cement, and for the unions using reinforcing mesh.

Furthermore, the coating composition of the present invention does detachment of the surfaces or body to which it is applied, resulting in a constant saving in maintenance costs.

According to an embodiment, a controlled segregation phenomena, by using different components which have various molecular miscibility properties among each other, that takes place during the curing and drying of the coating composition of the present invention, which obviates the need of producing layers of materials, since it is a self-assembling process. For example, the components of the coating composition will self-arrange at a molecular level to produce an organized layer. The different molecular structures of the components of the formulation of the present invention allow that some of them react with one another, chemically repeal others and segregate to the surface of the layer the components which will be in contact with the external environment. The different sizes, chemical affinities, densities and chemical miscibility of the ceramic and/or carbon nanoparticles, due to their surface modification with specific chemical groups, which comprise the core of our formulation, allow producing a chemically-driven nano- and micro-arrangement of the components of the coating composition of the present invention, which are responsible for their improved properties.

According to another embodiment, there is disclosed a process for preparing a ceramic and/or carbon nanoparticle having a chemically functionalized surface comprising:
a) contacting a ceramic and/or carbon nanoparticle with a functionalizing agent in the presence of an inert atmosphere in a suitable first solvent at a temperature and for a time sufficient to yield a functionalized ceramic and/or carbon nanoparticle.

According to another embodiment, the process may also comprise step b)
b) washing the functionalized ceramic and/or carbon nanoparticle in a second suitable solvent to obtain a washed functionalized ceramic and/or carbon nanoparticle.

According to another embodiment, the process may also include step c):
c) curing the washed functionalized ceramic and/or carbon nanoparticle to at a temperature and for a time sufficient to yield a cured functionalized ceramic and/or carbon nanoparticle.

According to another embodiment, the functionalizing agent may be any suitable reagent capable of reacting with the surface of the ceramic and/or carbon nanoparticle, including but not limited to 3-mercaptopropyltrimethoxysilane, (3-aminopropyl)-triethoxysilane, (3-aminopropyl)-diethoxy-methylsilane, (3-aminopropyl)-dimethyl-ethoxysilane, (3-aminopropyl)-trimethoxysilane and combinations thereof.

According to another embodiment, the inert atmosphere may be provided by any suitable means of providing such atmosphere, and preferably with a N₂ atmosphere or with a strong flux of clean, dried air, in an industrial environment.

According to another embodiment, time sufficient for contacting the ceramic and/or carbon nanoparticle may be from about 10 h to about 112 h. According to another embodiment, the time sufficient for curing the ceramic and/or carbon nanoparticle may be from about 8 h to about 12 h.

According to another embodiment, the temperature for contacting ceramic and/or carbon nanoparticles with the functionalizing agent may be from about 25° C. to about 70° C. According to yet another embodiment, the temperature for curing the ceramic and/or carbon nanoparticle may be from about 65° C. to about 130° C.

According to another embodiment, the first and second suitable solvents may be chosen from anhydrous xylene, dry toluene, xylene, toluene, ethanol, acetone, methyl amyl ketone, n-butyl propionate and isobutyl isobutyate and combinations and co-solvents prepared with them.

According to another embodiment, there is disclosed a process for the preparation of a dispersion comprising a ceramic and/or carbon nanoparticle having a chemically functionalized surface, the process comprising the steps of:

a) Chemical functionalization of the nanoparticles described above (silica, alumina, carbon, etc.), according to a typical scheme described below

b) dispersing a mixture of ceramic and/or carbon nanoparticles including at least one type of a ceramic and/or carbon nanoparticle having a chemically functionalized surface in a polymeric matrix, either by using a solvent or by using water.

c) curing of the mixture of the and/or carbon nanoparticles with the polymeric matrix, either a room conditions or by heating, by UV curing, by electron beam curing, or catalyzed by a reaction of reactive radicals.

The present invention will be more readily understood by referring to the following examples which are given to illustrate the invention rather than to limit its scope.

### Example 1

### Physical and Chemical Properties of a Composition Containing Ceramic Nanoparticles, Bactericide, Acrylic Polymer Resin with Styrene

A composition of the present invention comprising silicon dioxide nanoparticles (1 to 5% w/v), titanium dioxide nanoparticles (0.1 to 2% w/v), and zinc oxide nanoparticles (3 to 5% w/v) functionalized with carboxyl and amine groups on their respective surface, Methylene bis(thiocyanate) and/or 2-(Thiocyanomethylthio)benzothiazole (bactericide, 0.1 to 1% w/v), in an styrene-acrylic resin at a ratio of between 80 to 95%, the humectating-dispersing agent content is of the order of 1% to 5% and the rheological agent ranges 0.5% to 5%, depending of the specific commercial resin employed for the production.
Color: WHITE
Toxicity: NON-TOXIC TOXICITY
Flammability: SELF EXTINGUISHING
Water absorption: 0.04%
Density: 125 KG/MTS3
Thermal conductivity: K=0.059 BTU/HR
Flexibility: 500%
Reflection UV rays: 82%
RECOMMENDED THICKNESS: 10 to 15 thousandth of an inch (mils)
Emulsifier: Water
Adhesion: excellent
Acid environment resistance: GREAT
Alkaline environment resist: EXCELLENT
Salt spray resistance: EXCELLENT
Weathering tensile: More than 23.000 CYCLES
Asbestos content: ANY
IMPERMEABILITY: EXCELLENT
GROWTH OF FUNGI: NULL
THERMAL SHOCK: Does not CRACKS
WEIGHT (2 mm): 0.28 kg/m2

### Example 2

### Comparison with Competing Product

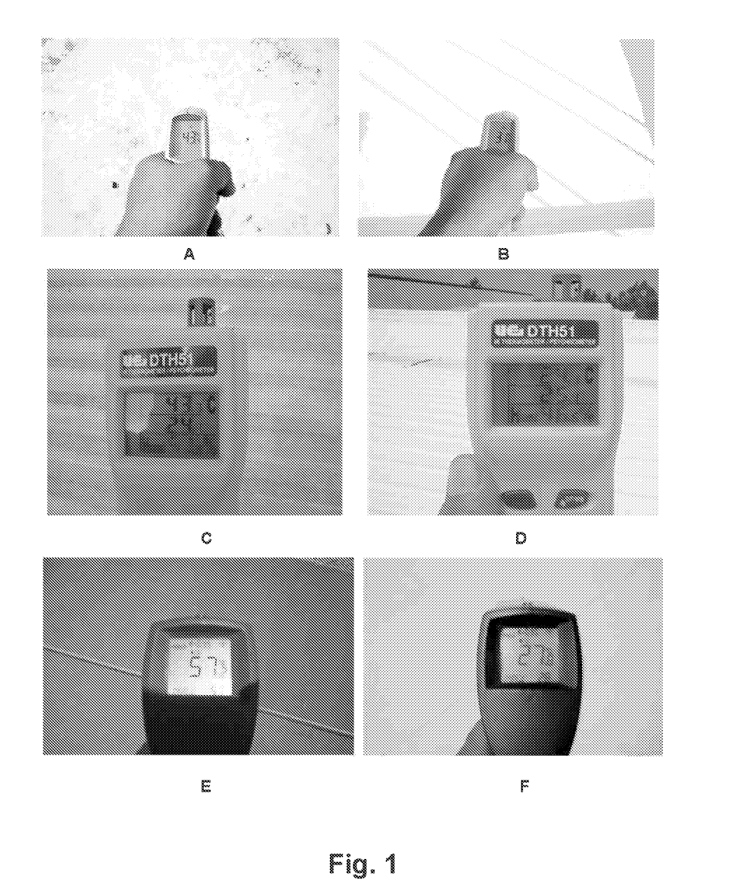

The composition of example 1 is compared to a competing product—SunGlare™ from Nasacoat™. Now referring to FIG. 1, it can be seen that an uncoated surface has an temperature of 43.4° C. (FIG. 1A), while an adjacent roof surface coated with SunGlare™ has a temperature of 31° C. (FIG. 1B), such that the actual outcome of SunGlare™ product reaches only approximately 28% decrease of the temperature of the roof. This outcome is considered relatively poor, since the original surface is made of concrete or cement. The outcome would have been much poorer had the surface been a galvanized sheet of metal, since the metal by nature tends to keep or retain more heat.

Next, galvanized metal sheets temperature is measure prior to treatment with the composition of the present invention, and after treatment with the composition of the present invention. As shown in FIG. 1C, the surface prior to treatment with the coating composition displays a temperature of 43.3° C., while after treatment (FIG. 1D), the temperature drops to 24.1° C.—a decrease of 44%.

Performing an identical experiment on a concrete surface covered with terracotta colored waterproofing, the temperature prior to treatment is 57.5° C., while after treatment it is 27.8° C. (Figs. E and F, respectively). In this case the temperature is decreased by more than 51%.

### Example 3

### Functionalization of Ceramic Nanoparticles #1

The use of silica micro and nanoparticles for immobilization of organic molecules includes a wide range of surface areas, ranging from around 200 m²/g up to nearly 1500 m²/g. As observed in Table 1, neither nanosized or microsized particles necessarily possess high surface areas. The details of the nanostructure and textural properties (porosity, etc.) are more relevant in this regard. The synthesis route is relevant for the surface area, and also the post-treatment (i.e. calcinations, for instance) plays a definitive role on the textural properties.

Silica nanoparticles are surface-functionalized with a mercaptane group, by using 3-mercaptopropyltrimethoxysilane (3-MPTS) as chelating agent. 3-MPTS is gradually added to the silica sols under reflux for 72 h in anhydrous xylene and N₂ atmosphere.

The resulting nanoparticles are washed with xylene and acetone and dried for 8 h at 100° C. The process is schematically described in Scheme 1.

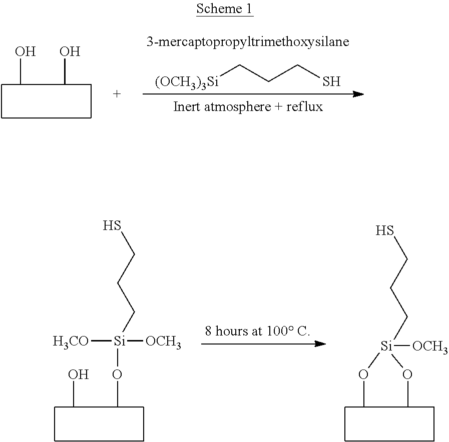

The quimisorption of mercaptane onto silica described here is the most efficient one, in terms of percentage of groups immobilized at the surface (25 to 30%).

The bonding of these molecules to the silica nanoparticles surface is carried out through a silanization process for which, first, the active H atoms of the surface silanol groups (≡Si—OH) of the silica, react with the organosilil [(OCₙH₂ₙ₊₁)ₓSi] of the above molecules, producing, on the one hand, an organic compound and, on the other, the bonding of the Si of the molecule to the O of the surface. This chemisorption provides immobilization, mechanical stability and insolubility, key factors for their further use an ion removing agents in aqueous solutions.

### Example 4

### Functionalization of Ceramic Nanoparticles #2

Another functional groups employed in the technology of the present invention is 3-aminopropyltrietoxysilane (3-APTS). 3-APTS is utilized, added under reflux for 12 h in dry toluene and under N₂ atmosphere. The resulting material is washed with toluene, ethanol and acetone and dried at 75° C. for 10 h. Scheme 2 shows schematically the process.

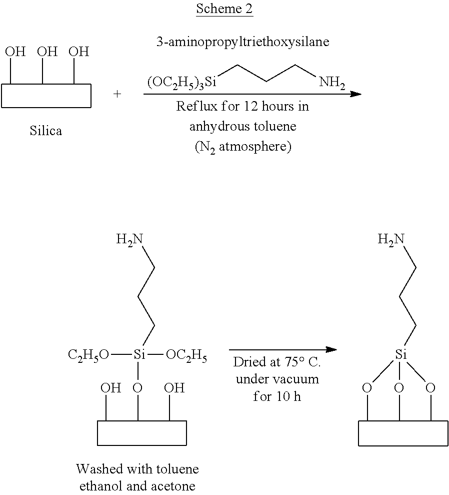

The bonding of these molecules to the silica nanoparticles surface is carried out through a silanization process for which, first, the active H atoms of the surface silanol groups (≡Si—OH) of the silica, react with the organosilil [(OCₙH₂ₙ₊₁)ₓSi] of the above molecules, producing, on the one hand, an organic compound and, on the other, the bonding of the Si of the molecule to the O of the surface. This chemisorption provides immobilization, mechanical stability and insolubility, key factors for their further use a ion removing agents in aqueous solutions.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A ceramic and/or carbon nanoparticle having a chemically functionalized surface, said ceramic and/or carbon nanoparticle having a size from about 8 nm to about 120 nm.

2. The ceramic and/or carbon nanoparticle of claim 1, wherein said ceramic and/or carbon nanoparticle is a nanoparticle made from a material chosen from an aluminum oxide (Al₂O₃), silicon dioxide (SiO₂), zirconium oxide (ZrO₂), titanium oxide (TiO₂), zinc oxide (ZnO), cerium oxide (IV) (CeO₂), beryllium oxide (BeO), calcium carbonate (CaCO₃), calcium phosphate [Ca₃(PO₄)₂], a carbide, a boride, a nitride, a silicide and a carbon nanotube.

3. The ceramic and/or carbon nanoparticle of claim 2, wherein said carbide is chosen from calcium carbide (CaC₂), boron carbide (B₄C), silicon carbide (SiC), titanium carbide (TiC), tungsten carbide (WC), iron carbide (Fe₃C), zirconium carbide (ZrC), hafnium carbide (HfC), vanadium carbide (VC), niobium carbide (NbC), a tantalum carbide (TaCₓ, wherein x is 0.4 to 1), a chromium carbide, and molybdenum carbide (Mo₂C).

4. The ceramic and/or carbon nanoparticle of claim 3, wherein said chromium carbide is chosen from Cr₃C₂, Cr₇C₃, and Cr₂₃C₆.

5. The ceramic and/or carbon nanoparticle of claim 2, wherein said boride is chosen from silicon triboride (SiB₃), silicon hexaboride (SiB₆), titanium diboride (TiB₂), zirconium diboride (ZrB₂), and hafnium diboride (HfB₂).

6. The ceramic and/or carbon nanoparticle of claim 2, wherein said nitride is chosen from titanium nitride (TiN), silicon nitride (Si₃N₄), and boron nitride (BN).

7. The ceramic and/or carbon nanoparticle of claim 2, wherein said carbon nanotube is chosen from a single wall nanotube, a multi-walled nanotube, or combinations thereof.

8. The ceramic and/or carbon nanoparticle of any one of claims 1 to 7, wherein said chemically functionalized surface comprises (a) a hydroxyl group, (b) a carboxyl group, (c) an amine group, (d) a C₁-C₃₀-alkyl group, linear or branched, unsubstituted or substituted with 1-3 halogens, or Na and unsubstituted or substituted with one group selected from —OH, an —OC₁₋₃₀ alkyl unsubstituted or substituted with 1-3 halogens or Na, an —SOₓC₁₋₃₀alkyl group, linear or branched, and —CN, (e) a —C(═O)H group, (f) a —C(═O)C₁₋₃₀alkyl group, linear or branched, unsubstituted or substituted with 1-3 halogens, (g) a —CN group, (h) a —HC═NOH group, (i) a —(CH₃)C═NOH group, (j) a —HC═NOC₁₋₃₀alkyl group, linear or branched, unsubstituted or substituted with 1-3 halogens, (k) a —(CH₃)C═NOC₁₋₃₀alkyl group, linear or branched, unsubstituted or substituted with 1-3 halogens (l) a —C(═O)OC₁₋₃₀ alkyl group, linear or branched, unsubstituted or substituted with 1-3 halogens, (m) a —C(═O)NHR⁶ group, (n) a —CH═CH-Phenyl group wherein —CH═CH— is unsubstituted or substituted with 1-2 substituents independently selected from halogen and C₁₋₂alkyl optionally substituted with 1-3 F, (o) a —CH₂CH₂-Phenyl wherein —CH₂CH₂— is unsubstituted or substituted with 1-4 substituents independently selected from halogen and C₁₋₂ alkyl unsubstituted or substituted with 1-3 F, (p) a Phenyl group, (q) a —HET-Phenyl group, wherein HET is a 5- or 6-membered heteroaromatic ring containing 1-3 heteroatoms selected from O, N and S, (r) a —C≡C-Phenyl group, and (s) a —CH₂-Phenyl group, wherein the —CH₂— group of —CH₂-Phenyl is unsubstituted or substituted with 1-2 substituents independently selected from halogen and C₁₋₂ alkyl unsubstituted or substituted with 1-3 F, (t) [symbol] (O)ₓSi(OCₙH₂ₙ₊₁)ₓ(CH₂)ₙR⁷, (u) [symbol] Si(OCₙH₂ₙ₊₁)ₓ(CH₂)ₙR⁷
wherein Phenyl and HET in all occurrences are unsubstituted or substituted with 1-3 substituents independently selected from (i) halogen, (ii) —C(═O)OC₁₋₃₀ alkyl unsubstituted or substituted with 1-3 halogens, (iii) —C(═O)OH (iv) C₁₋₃₀ alkyl unsubstituted or substituted with 1-3 halogens, (v) —OC₁₋₃₀ alkyl unsubstituted or substituted with 1-3 halogens, (vi) —SOₓMe, (vii) —SO₂NH₂, and combinations thereof;
R⁶ is selected from the group consisting of H, C₁₋₃₀alkyl unsubstituted or substituted with 1-3 halogens, Phenyl, and —CH₂-Phenyl, wherein Phenyl in both occurrences is unsubstituted or substituted with 1-3 substituents independently selected from (i) halogen, (ii) —C(═O)OC₁₋₃₀ alkyl unsubstituted or substituted with 1-3 halogens, (iii) —C(═O)OH (iv) C₁₋₃₀ alkyl unsubstituted or substituted with 1-3 halogens, and (v) —OC₁₋₃₀ alkyl unsubstituted or substituted with 1-3 halogens;
R₇ is selected from the group consisting of H, a hydroxyl group, a carboxyl group, an amine group, a thiol group, a C₁-C₃₀-alkyl group, linear or branched, unsubstituted or substituted with 1-3 halogens, or Na and unsubstituted or substituted with one group selected from —OH, an —OC₁₋₃₀ alkyl unsubstituted or substituted with 1-3 halogens or Na, an —SOₓC₁₋₃₀alkyl group, linear or branched, and —CN,
x is independently chosen from 0, 1, or 2,
n is independently chosen from 1 to 30, and [symbol]
is a single, double or triple bond,
and combinations thereof.

9. A ceramic and/or carbon nanoparticle dispersion comprising at least one ceramic and/or carbon nanoparticle having a chemically functionalized surface according to any one of claims 1 to 8, dispersed in a polymeric matrix.

10. The dispersion of claim 9, comprising from about 0.1% (w/v) to about 10% (w/v) of said ceramic and/or carbon nanoparticle having a chemically functionalized surface.

11. The dispersion of claim 9, wherein said polymeric matrix comprises an acrylic resin, an elastomeric resin, an epoxy resin, a polyurethane resin, an alkyd resin, a vinyl-acrylic resin, a polyester resin, a melamine resin, an oil or combinations thereof.

12. The dispersion of claim 11, wherein said acrylic resin is chosen from a polymethyl acrylate resin, polymethyl methacrylate resin, and combinations thereof.

13. The dispersion of claim 11, wherein said elastomeric resin is chosen from cis-1,4-polyisoprene natural rubber, and trans-1,4-polyisoprene gutta-percha, a synthetic polyisoprene, a polybutadiene, a polychloroprene, a copolymer of isobutylene and isoprene, an halogenated copolymer of isobutylene and isoprene, a copolymer of styrene and butadiene, a copolymer of butadiene and acrylonitrile, a copolymer of ethylene and propylene, an ethylene propylene diene rubber, a terpolymer of ethylene, a epichlorohydrin rubber, a polyacrylic rubber, a silicone rubber, fluorosilicone rubber, a fluoroelastomer, a perfluoroelastomers, polyether block amide elastomer, a chlorosulfonated polyethylene, and an ethylene-vinyl acetate.

14. The dispersion of any one of claims 1 to 13, further comprising an aluminum slurry.

15. The dispersion of claim 14, wherein said aluminum slurry comprises nanoparticles from about 1% (w/v) to about 3% (w/v).

16. The dispersion of claim 14, wherein said aluminum slurry comprises microparticles from about 2.5% (w/v) to about 50% (w/v).

17. The dispersion of any one of claims 1 to 16, further comprising a flame retardant.

18. The dispersion of claim 17, wherein said flame retardant is chosen from Huntite (Mg₃Ca(CO₃)₄), hydromagnesite (Mg₅(CO₃)₄(OH)₂.4H₂O), aluminium hydroxide (Al(OH)₃), magnesium hydroxide (Mg(OH)₂), a magnesium hydroxide particle, melamine cyanurate, melamine polyphosphate, or combinations thereof.

19. The dispersion of claim 18, wherein said magnesium hydroxide particle is a particle of size between about 100 nm to about 3000 nm.

20. The dispersion of claim 18, wherein said magnesium hydroxide particle is further coated with a layer of sodium stearate.

21. The dispersion of any one of claims 1 to 18, further comprising a rheology modifier.

22. The dispersion of claim 21, wherein said rheology modifier is chosen from a modified hydrogenated castor oil, a bentonite, a synthetic polyamide wax, a polysaccharide, and combinations thereof.

23. The dispersion of claim 22, wherein said polysaccharide is chosen from a methylcellulose, a hydroxypropyl methylcellulose, a hydroethylcellulose, a methyl ethyl hydroxyethyl cellulose, a hydrophobical modified ethyl hydroxyethyl cellulose, an ethylene-vinyl-acetate copolymer, an emulsion of an ethylene-vinyl-acetate copolymer, and combinations thereof.

24. The dispersion of any one of claims 1 to 22, further comprising a thickening agent.

25. The dispersion of claim 24, wherein said thickening agent is chosen from an acrylic thickener, a polyvenyle co-polymer and a polyvenyle homopolymer.

26. The dispersion of any one of claims 1 to 25, further comprising an anti-bacteria chemical.

27. The dispersion of claim 26, wherein said anti-bacteria chemical is chosen from methylene bis(thiocyanate), 2-(Thiocyanomethylthio)benzothiazole, thiodazine-thione, 2,3,4,6-tetrachloro 4(methylsulfonyl)pyridine, silver nanoparticles or combinations thereof.

28. The dispersion of claim 27, wherein said silver nanoparticles have size ranging between about 10 to about 90 nm.

29. The dispersion of any one of claims 1 to 14, wherein said dispersion has a thermal conductivity (K) between about 0.001 and about 0.1 BTU/h.

30. The dispersion of any one of claims 1 to 14, wherein said dispersion reflects up to 82% of UV radiation.

31. The dispersion of any one of claims 1 to 14, wherein said paint composition has a density between about 0.97 to about 1.42 Kg/m³ (Kg/L).

32. A coating composition comprising the dispersion of any one of claims 9 to 31 in association with a medium.

33. The coating composition of claim 14, wherein said medium is a paint, a stain, a lacquer or a grout.

34. The coating composition of any one of claims 32 to 33, further comprising at least one colored pigment.

35. The coating composition of claim 34, wherein said colored pigment is a nanopigment having a concentration from about 0.1% (w/v) to about 3% (w/v).

36. The coating composition of claim 34, wherein said colored pigment is a micropigment having a concentration from about 2.5% (w/v) to about 50% (w/v).

37. The coating composition of any one of claims 32 to 36, wherein said coating composition is waterproof.

38. The coating composition of any one of claims 32 to 37, wherein said coating composition is resistant to fungal growth.

39. A surface coated with the coating composition of any one of claims 32 to 38.

40. A process for preparing a ceramic or carbon nanoparticle having a chemically functionalized surface comprising:
a) contacting a ceramic and/or carbon nanoparticle with a functionalizing agent in the presence of an inert atmosphere in a suitable first solvent at a temperature and for a time sufficient to yield a functionalized ceramic and/or carbon nanoparticle.

41. The process of claim 40, further comprising step b):
b) washing said functionalized ceramic and/or carbon nanoparticle in a second suitable solvent to obtain a washed functionalized ceramic and/or carbon nanoparticle.

42. The process of claim 41, further comprising step c):
c) curing said washed functionalized ceramic and/or carbon nanoparticle to at a temperature and for a time sufficient to yield a cured functionalized ceramic and/or carbon nanoparticle.

43. The process of any one of claims 40 to 42, wherein said functionalizing agent is chosen from 3-mercaptopropyltrimethoxysilane, (3-aminopropyl)-triethoxysilane, (3-aminopropyl)-diethoxy-methylsilane, (3-aminopropyl)-dimethyl-ethoxysilane, (3-aminopropyl)-trimethoxysilane and combinations thereof.

44. The process of any one of claims 40 to 43, wherein said inert atmosphere is a N₂ atmosphere, or with a strong flux of clean, dried air, in an industrial environment.

45. The process of any one of claims 40 to 44, wherein said time sufficient is from about 10 h to about 112 h.

46. The process of any one of claims 40 to 45, wherein said first suitable solvent is chosen from anhydrous xylene, dry toluene, methyl amyl ketone, n-butyl propionate and isobutyl isobutyrate and combinations and co-solvents prepared with them.

47. The process of any one of claims 41 to 46, wherein said second suitable solvent is chosen from xylene, toluene, ethanol, acetone, methyl amyl ketone, n-butyl propionate and isobutyl isobutyrate and combinations and co-solvents prepared with them.

48. The process of claim 40, wherein said temperature is chosen from about 25° C. to about 70° C.

49. The process of claim 42, wherein said temperature is from about 65° C. to about 130° C.

50. The process of claim 42, wherein said time sufficient is from about 8 h to about 12 h.

51. A process for the preparation of a dispersion comprising a ceramic and/or carbon nanoparticle having a chemically functionalized surface, the process comprising the steps of:
a) dispersing a mixture of ceramic nanoparticles including at least one type of a ceramic and/or carbon nanoparticle having a chemically functionalized surface in a polymeric matrix, by using a solvent or water; and
b) curing said mixture of the and/or carbon nanoparticles in the polymeric matrix.

52. The process of claim 51, wherein curing is at room temperature, by heating, by UV curing, by electron beam curing, or catalyzed by a reaction of reactive radicals.

53. The process of claim 51, comprising step a′) prior to step a):
a′) chemically functionalizing a ceramic and/or carbon nanoparticles described according to any one of claims 40 to 49.
